(19) United States
(12) Patent Application Publication
(10) Pub. No.: US 2003/0090606 A1
(43) Pub. Date: May 15, 2003

(54) Light guiding plate, liquid crystal display device using the same, and method for displaying pictures thereof

(76) Inventors: Ik-Soo Lee, Suwon-si (KR); Jin-Baek Kim, Gunpo-si (KR)

Correspondence Address: Daniel F. Drexler, 55 Griffin South Road, Bloomfield, CT, 06002, US

(21) Appl. No.: 10/244,492

(22) Filed: Sep. 16, 2002

(30) Foreign Application Priority Data
Nov. 13, 2001 (KR) 2001-70566

(51) Int. Cl. G02F 1/1335

(52) U.S. Cl. 349/65

(57) ABSTRACT

Disclosed are a light guiding plate, a liquid crystal display device using the same, and a method for displaying an image thereof. The light reflection path is varied in the guiding plate, such that a portion of the light supplied to a bright region of an effective display area is shifted into a dark region, thereby obtaining a uniform brightness distribution over the entire effective display area. The liquid crystal display device can display information with improved brightness, so that the display quality is improved.

### BACKGROUND OF THE INVENTION

1. Field of the Invention

The present invention relates to a liquid crystal display device, and more particularly to a light guiding plate, a liquid crystal display device using the same, and a method for displaying an image using the same, in which the display function is remarkably improved by optimizing brightness balance in an effective display area.

2. Description of the Related Art

A liquid crystal display device is one of flat display devices, which precisely controls a light transmission of a liquid crystal so as to allow a user to recognize information processed in an information processing unit.

The liquid crystal display devices are generally classified into a transmission type liquid crystal display device and a reflection type liquid crystal display device. The reflection type liquid crystal display device is mainly used for a small-size or a middle-size display device and the transmission type liquid crystal display device is mainly used for a middle-sized or a large-sized display device.

Since the reflection type liquid crystal display device displays an image by using an external light source, it has a simple structure.

In addition, the reflection type liquid crystal display device has a low power consumption when displaying an image because it can display an image with a little power required for controlling a liquid crystal.

However, the reflection type liquid crystal display device does not precisely display an image at night or when the quantity of light required for displaying information is insufficient.

Such problems can be solved with the transmission type liquid crystal display device. Different from the reflection type liquid crystal display device, the transmission type liquid crystal display device generates a light by consuming an electric energy. The transmission type liquid crystal display device displays an image by using the light. As a result, the transmission type liquid crystal display device can freely display an image in any place regardless of an environmental condition.

However, the transmission type liquid crystal display device needs an additional power to generate the light for displaying an image besides the power for controlling the liquid crystal, so the power consumption thereof increases when compared with that of the reflection type liquid crystal display device.

In addition, the transmission type liquid crystal display device requires a plurality of members for obtaining a uniform optical distribution of the light generated for displaying an image. For this reason, the transmission type liquid crystal display device has a complicated structure, which complicates manufacturing process, and increases manufacturing time and cost.

A front illumination type liquid crystal display device solves the problems of the transmission and reflection type liquid crystal display devices and maintains advantages thereof,.

The front illumination type liquid crystal display device displays information by using an external light when the external light is sufficient. On the other hand, when the external light is insufficient, the front illumination type liquid crystal display device displays an image by using an artificial light, which is generated by consuming an electric energy. As a result, the front illumination type liquid crystal display device can display an image in any place with a reduced power consumption compared with the transmission type liquid crystal display device.

In addition, the front illumination type liquid crystal display device only requires a light guiding plate for uniformly distributing the artificial light, so the structure thereof is very simple.

FIG. 1 shows a conventional front illumination type liquid crystal display device 10 (hereinafter, simply referred to as “liquid crystal display device”).

Referring to FIG. 1, the conventional liquid crystal display device 10 has a front light assembly 3 including a light source 1 and a light guiding plate 2, and a liquid crystal display panel assembly 9.

The liquid crystal display panel assembly 9 has a liquid crystal display panel 7 including a TFT substrate 5 having a pixel electrode, a TFT, and a signal line, a liquid crystal 6, and a color filter substrate 4 having a common electrode opposite the pixel electrode and R.G.B. color pixels, and a driving module 8 for driving the liquid crystal display panel 7.

The liquid crystal display panel assembly 9 precisely controls the alignment of the liquid crystal by a microscopic area unit. However, in a place where the light is insufficient or does not exist, the liquid crystal display device 10 does not display information even where the liquid crystal of the liquid crystal display panel assembly 9 is precisely controlled, because the liquid crystal 6 itself does not generate the light required for displaying an image.

Therefore, as shown in FIG. 1, the front light assembly 3 including the light source 1 and the light guiding plate 2 is required for displaying an image in the liquid crystal display device 10.

Preferably, the light source 1 for supplying the light to the liquid crystal display panel assembly 9 does not show a brightness variation within a predetermined area, just like sunlight. However, it is very difficult to manufacture the light source 1 having the brightness distribution similar to that of the sunlight. Thus, a linear light source or a point light source which has a high brightness and can be easily manufactured is used as the light source 1.

However, the linear light source and the point light source show a remarkable brightness variation depending on a distance between the light source and a light incident portion. Therefore, if the light generated from the linear light source or the point light source is directly supplied to the liquid crystal display panel assembly 9, display failure, such as a division of a screen or a spot on the screen, can be generated due to the remarkable brightness variation.

For this reason, as shown in FIG. 1 or 2, the light guiding plate 2 is used for obtaining a surface light source effect similar to the sunlight, from the light generated by the linear light source or the point light source.

The light guiding plate 2 has a hexagonal plate shape with a thin thickness, which corresponds to the shape of an effective display area of the liquid crystal display device 10.

The light guiding plate 2 varies the optical distribution of the light. In detail, the light guiding plate 2 allows the light concentrated in a small area to be uniformly distributed in a large area. In addition, the light guiding plate 2 varies the direction of the light having the varied optical distribution to be directed into the liquid crystal display panel assembly 9.

Where the light is leaked from the light guiding plate 2, which transfers the light generated from the light source 1 to the liquid crystal display panel assembly 9 by processing the light, the quantity of the light supplied to the liquid crystal display panel assembly 9 is reduced, so the optical efficiency can be lowered. In order to prevent the deterioration of the optical efficiency, a plurality of light reflection patterns 2a are formed on an upper surface of the light guiding plate 2. The plurality of light reflection patterns 2a, as shown in FIG. 2, is in the form of V-shaped grooves.

Since the light reflection patterns 2a are formed in the form of continuous V-shaped grooves, reflection surfaces 2c and non-reflection surfaces 2b are alternately formed in the light reflection patterns 2a. Angles β between reflection surfaces 2c of the light reflection patterns 2a and an underside 2d of the light guiding plate 2 are constantly formed as 42 degrees. Since angles β are formed as being constant, angles α between the non-reflection surfaces 2b and the underside 2d are also formed as being constant.

Optical efficiency can be adjusted by adjusting directions of the light reflection patterns 2a formed on the upper surface of the light guiding plate 2 and the pixel electrode formed on the TFT substrate 5. The reason is that the moiré, which is an optical interference phenomenon, is generated depending on the directions of the light reflection patterns 2a and the pixel electrode.

The moiré phenomenon lowers the display characteristic of the liquid crystal display device 10. In order to reduce the moiré phenomenon, as shown in FIG. 3, the aligning direction of the pixel electrode 5a is offset from the direction of light reflection patterns 2f at an angle of 22.5 degrees.

Though the moiré phenomenon is prevented by forming the light reflection patterns 2f on the light guiding plate 2, the display characteristic of the light guiding plate 2 is lowered if the brightness pattern is not uniform. As described above, the brightness varies depending on the distance between the light source and the light incident portion. Thus, the brightness is increased as the light source 1 approaches the light guiding plate 2, and the brightness is lowered as the light source 1 is remote from the light guiding plate 2. This will be explained in detail with reference to FIGS. 4 and 5.

The liquid crystal display device 10 is prepared, in which the light source 1 is positioned at a side of the light guiding plate 2 formed with the light reflection pattern 2f and the liquid crystal display panel assembly 9 is assembled at a lower portion of the light guiding plate 2.

Then, the light source 1 of the liquid crystal display device 10 is turned on and the brightness variation in the effective display area of the liquid crystal display device 10 is measured. The brightness variation is measured from plural points, for example nine points. The measuring points should not be concentrated in a predetermined part or not be spaced too much apart from each other.

FIG. 5 shows a graph representing the measuring result of the relative brightness. Referring to the graph shown in FIG. 5, the brightness at the effective display area varies depending on the distance between the light source 1 and the measuring point. That is, the brightness decreases as the distance increases.

In detail, measuring points 1, 4 and 7 represent the high brightness distributions, and measuring points 3, 6 and 9 have relatively low brightness distributions. It means that the light is insufficiently supplied from the light source 1 as the distance increases, that is, the light is insufficiently supplied to the measuring points 3, 6 and 9 from the light source 1.

On the contrary, a relatively high amount of the light is supplied to the measuring points 1, 4 and 7, so an excessively high brightness is obtained at the measuring points 1, 4 and 7.

The liquid crystal display device 10 having a poor brightness balance does not provide a desirable display characteristics.

### SUMMARY OF THE INVENTION

The present invention provides a light guiding plate capable of enhancing a brightness balance in an effective display area.

The present invention also provides a liquid crystal display device capable of performing a high quality display.

Also, the present invention provides a method for displaying pictures capable of performing a high quality display.

In one aspect, there is provided a light guiding plate comprising a light incident side portion into which a light is incident. A first surface reflects the light incident through the light incident side portion and has light a reflection pattern including a plurality of light reflection planes and non-reflection planes which are alternately disposed. A second surface is disposed opposite the first surface. The light reflection plane has an inclined angle with respect to the second surface, and the angle is proportional to a distance between the light incident side portion and the light reflection plane.

In another aspect, there is provided a liquid crystal display device including a lamp assembly for generating a light to supply the light in one direction. A light guiding plate has a light incident side portion into which the light is incident. A first surface has a light reflection pattern including a plurality of alternately disposed light reflection planes and non-reflection planes. A second surface has an inclined angle with respect to the second surface, and the angle is proportional to a distance between the light incident side portion and the light reflection plane. A liquid crystal display panel assembly forms an image light including display information by optically modulating the light projected from the second surface of the light guiding plate.

In still another aspect, there is provided a method for displaying an image in a liquid crystal display device. A first light having a first optical distribution is inputted. A second light having a second optical distribution is formed by continuously reflecting the first light. A third light is formed to have a third optical distribution by transmitting a portion of the second light and reflecting again at least one time a remaining portion of the second light and transmitting the re-reflected second light, depending on the reflection angle. A fourth light is formed to have information by optically modulating the third light through a liquid crystal.

According to the present invention, in a dark region having an insufficient quantity of light, the liquid crystal display device displays information by using an energy charged therein. In addition, in a bright area having a sufficient quantity of light, the liquid crystal display device displays information by using an external light. When displaying information by using the energy charged therein, the brightness uniformity of the liquid crystal display device can be more improved, so that a high quality display can be achieved.

### BRIEF DESCRIPTION OF THE DRAWINGS

The above and other advantages of the present invention will become more apparent by describing in detail exemplary embodiments thereof with reference to the attached drawings in which:

FIG. 1 is a schematic view of a conventional liquid crystal display device;

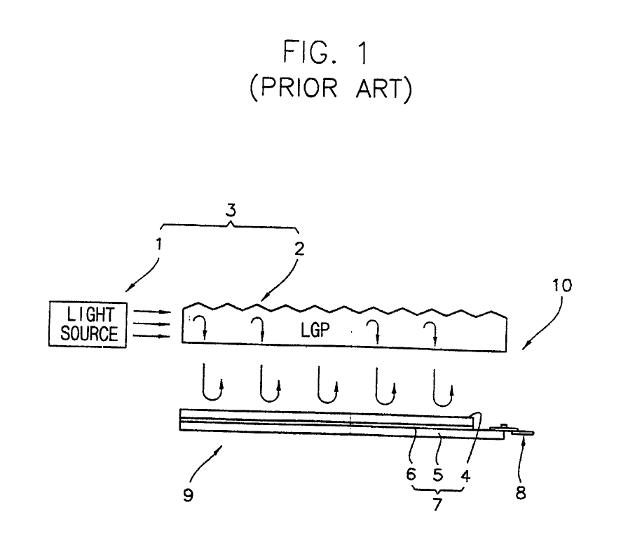

FIG. 2 is a sectional view showing a light reflection pattern formed on an upper surface of the conventional liquid crystal display device;

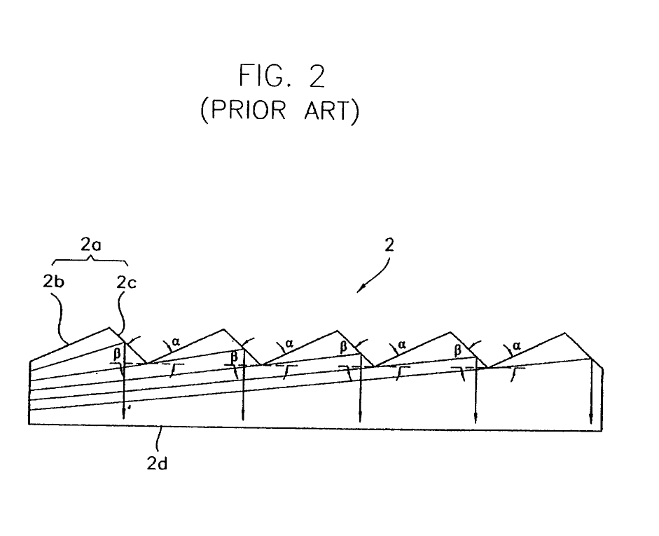

FIG. 3 is a schematic view showing a pixel electrode tilted with respect to a light reflection pattern of the conventional liquid crystal display device;

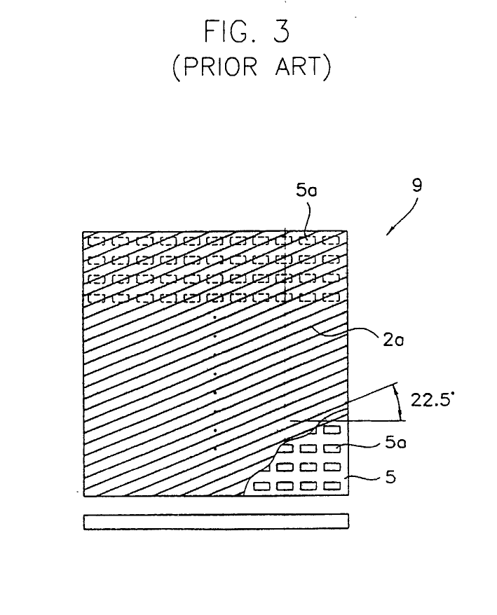

FIG. 4 is a schematic view showing a method for measuring a brightness at plural points of an effective display area of the conventional liquid crystal display device as shown in FIG. 3;

FIG. 5 is a graph showing the brightness at each measuring point of FIG. 4;

FIG. 6 is an exploded perspective view of a front illumination type liquid crystal display device according to one embodiment of the present invention;

FIG. 7 is an enlarged view showing a portion of a TFT substrate shown in FIG. 6;

FIG. 8 is a sectional view of a light guiding plate according to one embodiment of the present invention;

FIG. 9 is a view for explaining an optical shift in a light guiding plate according to one embodiment of the present invention;

FIG. 10 is a view showing a method for measuring the brightness in a liquid crystal display device according to one embodiment of the present invention;

FIG. 11 is a plan view showing brightness measuring points in a liquid crystal display device according to one embodiment of the present invention;

FIG. 12 is a graph showing the brightness measured in a liquid crystal display device according to one embodiment of the present invention; and

FIG. 13 is a view showing a method for displaying pictures in a liquid crystal display device according to one embodiment of the present invention.

### DETAILED DESCRIPTION OF THE INVENTION

Hereinafter, a light guiding plate and a liquid crystal display device using the same according to one embodiment of the present invention will be described in detail.

The liquid crystal display device according to the embodiment of the present invention is a “front illumination type liquid crystal display device”. The front illumination type liquid crystal display device displays an image by using an external light in a place having a sufficient external light, and displays information by using an “artificial light”, which is generated by consuming an electric energy, in a dark place. Therefore, the front illumination type liquid crystal display device is advantageous in view of the volume, weight and power consumption.

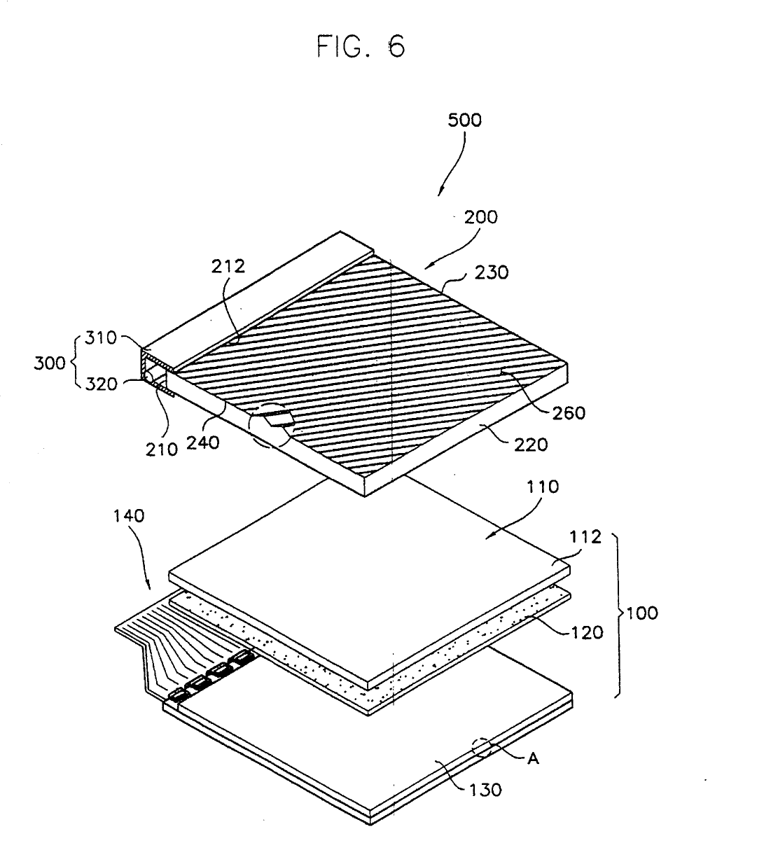

As shown in FIG. 6, the front illumination type liquid crystal display device 500 includes a reflection type liquid crystal display panel assembly 100, light guiding plate 200, and a lamp assembly 300, which generates a light by consuming an electric energy.

The reflection type liquid crystal display panel assembly 100 is adapted for adjusting the transmissivity of the “external light” or “artificial light” so as to properly display information.

Referring to FIG. 6, the reflection type liquid crystal display panel assembly 100 includes a color filter substrate 110, a liquid crystal layer 120, a TFT substrate 130, and a driving module 140.

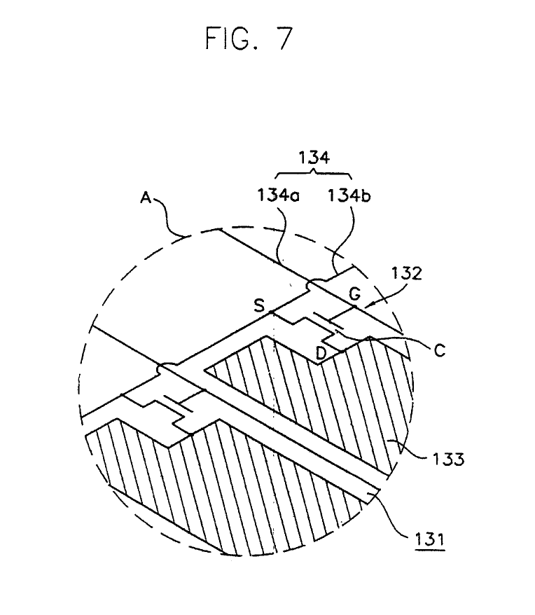

In detail, referring to FIG. 7, the TFT substrate 130 includes a base substrate 131, thin film transistors 132, reflection electrodes 133 and signal lines 134.

More particularly, the thin film transistors 132 are formed on an upper surface of the base substrate 131 in a matrix pattern by, for example, a semiconductor manufacturing process. The thin film transistors 132 have gate electrodes G, source electrodes S, drain electrodes D and channel layers C selectively having a conductive or a non-conductive characteristic.

The gate electrodes G and the source electrodes S of the thin film transistors 132 are connected to the signal lines 134. In detail, conductive gate lines 134a are connected to the gate electrodes G of the thin film transistors in row directions of the matrix type thin film transistors 132. In addition, conductive data lines 134b are connected to the source electrodes S of the thin film transistors in column directions of the matrix type thin film transistors 132.

On the drain electrodes D of the thin film transistors 132, the reflection electrode 133 is formed of a conductive metal having a high light reflectivity. In addition, as shown in FIGS. 6 and 7, the driving module 140 for generating a driving signal is installed at the gate lines 134a and the data lines 134b.

The power is sequentially applied to each of data lines 134b and the turn-on power is repeatedly applied to the desired gate line 134a, so that the desired power is applied to all of the reflection electrodes 133.

As shown in FIG. 6, the color filter substrate 110 is formed on an upper surface of the TFT 130 having the above structure. The color filter substrate 110 includes a transparent substrate 112, R.G.B color pixels (not shown) patterned on the transparent substrate 112, and a common electrode made of a transparent conductive material. The R.G.B. color pixels are opposite the reflection electrode 133 formed on the TFT substrate 130.

In addition, a liquid crystal layer 120 is formed between the color filter substrate 110 and the TFT substrate 130, such that the light transmissivity thereof is varied depending on the intensity of the electric field.

In order to display information, the light is supplied to the reflection type liquid crystal display panel assembly 100 and the driving signal is applied to the signal lines 134.

The light required for driving the reflection type liquid crystal display panel assembly 100 includes the above-mentioned “external light” such as sunlight, or the “artificial light” generated by consuming the electric energy which is externally supplied or stored in the liquid crystal display device.

According to the one embodiment of the present invention, as shown in FIG. 6, the lamp assembly 300 is used for displaying information in a dark place. The lamp assembly 300 includes a lamp cover 310 and a lamp 320. For example, a cold cathode ray tube type lamp is used for the lamp 320.

Though the light generated from the cold cathode ray tube type lamp 320 is suitable for a general illumination purpose, it is unsuitable for an information displaying purpose.

Since the light generated from the cold cathode ray tube type lamp 320 has a long life span and is easily produced, it is suitable for the general illumination purpose. On the contrary, the light generated from the cold cathode ray tube type lamp 320 represents an extreme brightness variation according to a distance between the light source and a light incident portion, so it is difficult to form an image having a uniform brightness. Accordingly, the light generated from the cold cathode ray tube type lamp 320 is unsuitable for the information displaying purpose.

In this embodiment, the cold cathode ray tube type lamp 320 is used together with an optical distribution varying device called “light guiding plate 200”.

By using the light guiding plate 200, it is possible to display information with various advantages of the cold cathode ray tube type lamp 320, while overcoming the disadvantage of the cold cathode ray tube type lamp 320.

In detail, the light guiding plate 200 is positioned on an upper surface of the above-mentioned reflection type liquid crystal display panel assembly 100 in the front illumination type liquid crystal display device 500 so as to display information by using both external light and artificial light.

The light guiding plate 200 converts the light having an optical distribution concentrated in a small region, such as a linear light source optical distribution, into the light having a uniform optical distribution over a large region.

Hereinafter, the structure of the light guiding plate 200 used in the front illumination type liquid crystal display device 500 will be described in detail.

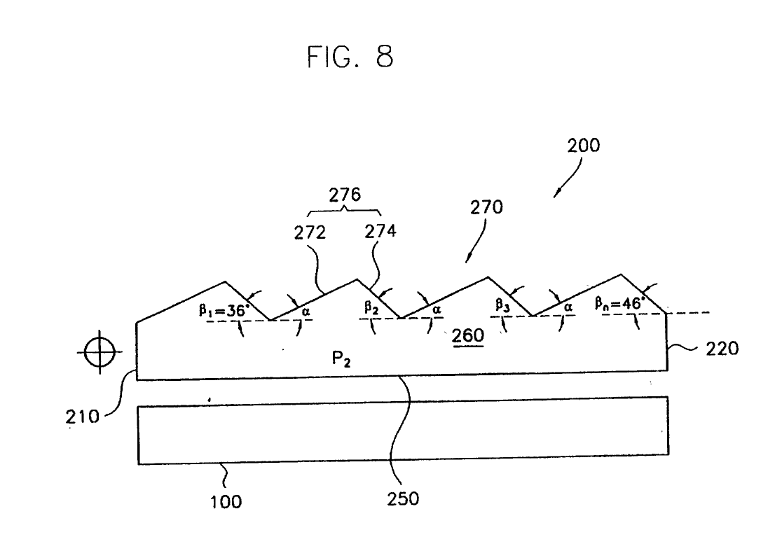

Referring to FIG. 6 or FIG. 8, the light guiding plate 200 is in the form of a three dimensional structure having a predetermined optical refractivity to vary the optical distribution of the light.

For example, the light guiding plate 200 includes a plurality of side sections and two opposing surfaces respectively formed at upper and lower ends of the side sections.

The shape of the light guiding plate 200 corresponds to a shape of the reflection type liquid crystal display panel assembly 100. In detail, the light guiding plate 200 is manufactured to have a shape identical to the shape of the reflection type liquid crystal display panel assembly 100. For example, where the reflection type liquid crystal display panel assembly 100 is manufactured in a hexagonal shape, the light guiding plate 200 is also manufactured in the hexagonal shape.

In one embodiment, since the reflection type liquid crystal display panel assembly 100 is manufactured in a hexagonal plate shape, the light guiding plate 200 also has the hexagonal plate shape.

Therefore, the light guiding plate 200 has four side sections 210, 220, 230, and 240, a first surface 260, and a second surface 250 opposite the first surface 260.

Among four side sections 210, 220, 230, and 240 of the light guiding plate 200, one side section directly faces the lamp assembly 300. The side section facing the lamp assembly 300 to receive the light having a densely distributed optical distribution is defined as a “light incident side section”, which is represented by “210”.

The light supplied to the light guiding plate 200 through the light incident side section 210 reaches the first surface 260 adjacent to the light incident side section 210 through various paths. Two paths are explained herein in detail.

A first path is formed where the light passing through the light incident side section 210 directly reaches the first surface 260 without any reflections. A second path is formed where the light passing through the light incident side section 210 indirectly reaches the first surface 260 by being reflected by the second surface 250 at least one time.

In both cases, the light reaching the first surface 260 is reflected towards the reflection type liquid crystal display panel assembly 100. While the light is being reflected by the first surface 260, the optical distribution of the light is varied from a dense distribution concentrated on a limited area to an expanded distribution over an enlarged area.

In order to effectively reflect the light by the first surface 260, the “light reflection pattern 270” is formed on the first surface 260, as shown in FIG. 8.

Referring to FIGS. 6-9, the light reflection pattern 270 preferably has “a plurality of unit light reflection sections 276, which are continuously and parallelly arranged on the first surface 260 while being clockwise tilted about 22.5 degree with respect to a boundary line 212 formed between the light incident side section 210 and the first surface 260, in order to prevent the moiré phenomenon

The shape of the unit light reflection sections 276 forming the light reflection pattern 270 is illustrated in FIG. 8. Referring to FIG. 8, the unit light reflection sections 276 are defined by continuously forming V-shaped elongated grooves on the upper portion of the first surface 260 in a row direction. That is, the unit light reflection section 276 has a shape similar to a prism formed by one plane of a V-shaped elongated groove and opposite plane of an adjacent V-shaped elongated, groove.

Since the unit light reflection section 276 has a prism shape, each of the unit light reflection sections 276 includes two inclined planes 272 and 274.

The light inputted through the above-mentioned light incident side section 210 reaches one of two inclined planes 272 and 274. The inclined plane, which the incident light reaches, faces the light incident side section 210.

Hereinafter, the inclined plane, which the light incident through the light incident section 210 directly reaches, is referred to as a light reflection plane 274. The other inclined plane is referred to as a non-reflection plane 272.

The brightness variation can occur in the effective display area of the front illumination type liquid crystal display device 500 depending on the angle between the light reflection plane 274 and the second surface 250.

In order to decrease the brightness variation, the angle between the light reflection plane 274 and the second surface 250 is adjusted. That is, the angle is adjusted such that the light is shifted from a place having sufficient quantity of light to a place having insufficient quantity of light in the effective display area, so the brightness variation and the moiré phenomenon are simultaneously prevented.

The light shift from the place having sufficient quantity of light to the place having insufficient quantity of light is determined depending on whether the light supplied through the light incident side section 210 and reflected by the light reflection plane 274 is transmitted through the second surface 250 or reflected again by the second surface 250.

In detail, in order to adjust the optical balance through the light shift in the place having excessive quantity of the light, the transmissivity of the light is lowered when the light reflected by the light reflection plane 274 is transmitted through the second surface 250, and the reflectivity thereof is increased. The transmissivity and the reflectivity have a trade-off relationship. The light reflected by the second surface 250 is directed towards the place having an insufficient quantity of the light.

For this reason, the light transmissivity and the light reflectivity at the second surface 250 are depending on the angle formed between the light reflection plane 274 and the second surface 250. The plurality of the light reflection planes 274 for adjusting the light transmissivity and the light reflectivity have different angles with respect to the second surface 250 from each other.

In detail, the inclined angles between the light reflection plane 274 and the second surface 250 are gradually reduced as the light reflection plane 274 approaches the cold cathode ray tube type lamp 320. On the contrary, the inclined angles between the light reflection planes 274 and the second surface 250 are gradually enlarged as the light reflection plane 274 is remote from the cold cathode ray tube type lamp 320.

It is difficult to pass the light reflected by the light reflection plane 274 through the second surface 250 as the angle between the light reflection plane 274 and the second surface 250 becomes smaller. On the contrary, the light reflected from the light reflection side 274 easily passes through the second surface 250 as the angle between the light reflection plane 274 and the second surface 250 becomes larger.

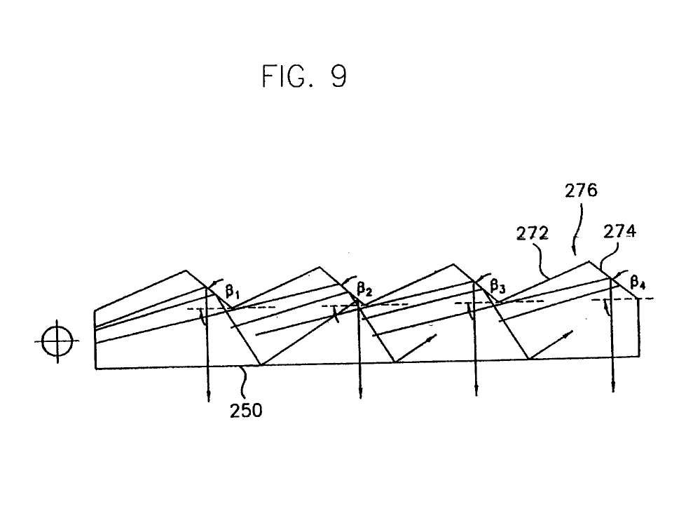

For example, referring to FIG. 8 or FIG. 9, the light reflection plane formed in a closest position to the cold cathode ray tube type lamp 320 has an inclined angle (β1) of about 35±3 degrees with respect to the second surface 250. In addition, the light reflection plane formed in a farthest position to the cold cathode ray tube type lamp 320 has an inclined angle (β4) of about 42±4 degrees with respect to the second surface 250.

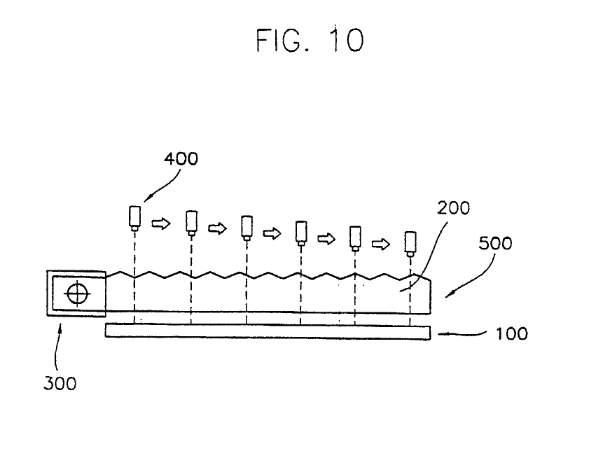

In order to verify the effect of the inclined angle of the light reflect plane on the brightness, as shown in FIGS. 10 to 12, brightness is measured at a front side of the display panel by using a detector 400. To this end, the light guiding plate 200 is assembled with the liquid crystal display panel assembly 100, in which the inclined angles of the light reflection planes are set to be gradually increased as the light reflection planes are remote from the cold cathode ray tube type lamp 320.

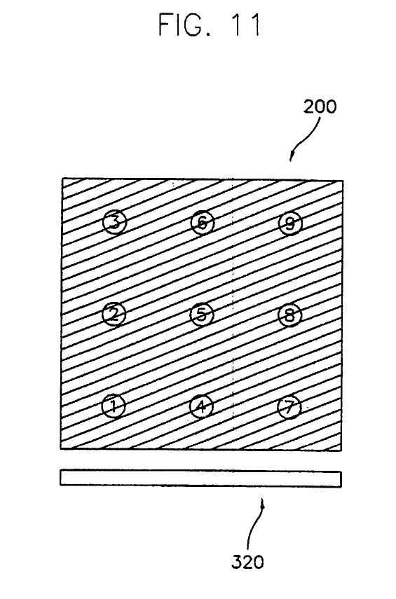

Referring to FIGS. 10 and 11, the detector 400 measures the brightness at nine measuring points at the effective display area of the liquid crystal display panel assembly 100.

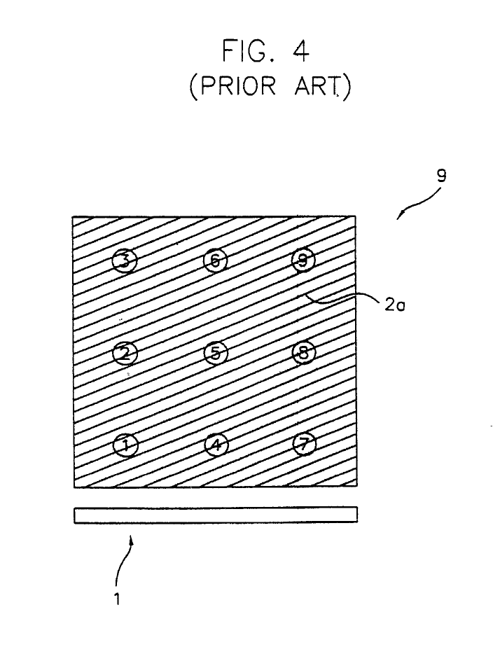

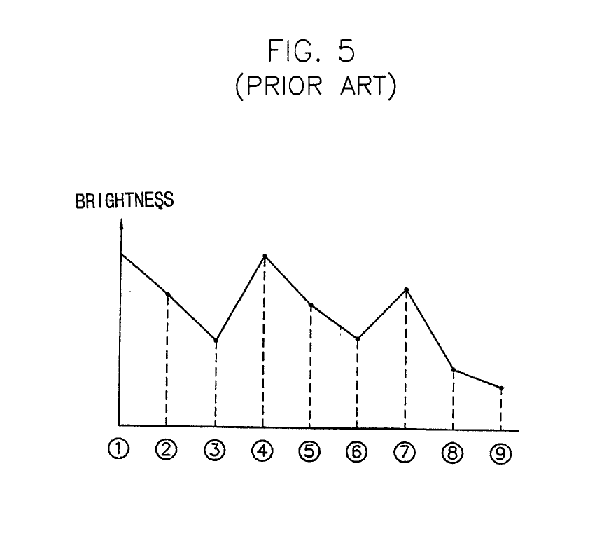

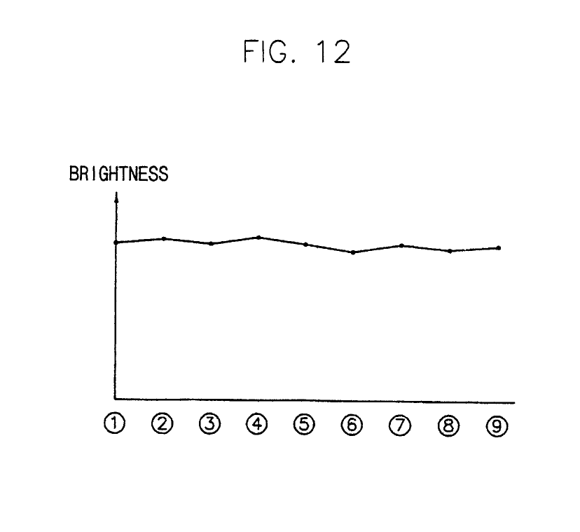

FIG. 12 shows a graph representing the measuring result of the relative brightness obtained from nine measuring points. Referring to FIG. 12, the measuring result represents that the brightness variation over the entire effective display area is reduced as compared with the conventional brightness variation shown in FIGS. 4 and 5.

Conventionally, the brightness increases at a position which is close to the cold cathode ray tube type lamp 320 and is lowered as at a position which is remote from the cold cathode ray tube type lamp 320. However, referring to FIGS. 11 and 12, the brightness is uniform regardless of the distance with respect to the cold cathode ray tube type lamp 320.

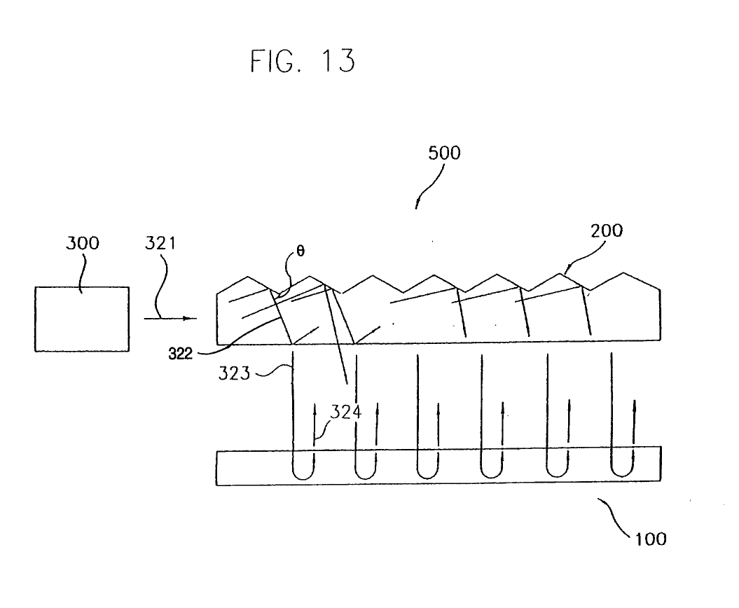

FIG. 13 shows a method for displaying an image in the liquid crystal display device.

The lamp assembly 300 generates a first light 321 having a first optical distribution. The first light 321 having the first optical distribution is a linear light source, so it has a non-uniform brightness distribution.

The first light 321 is incident into the light guiding plate 200. The first light 321 incident into the light reflection plane 274 of the light guiding plate 200 is reflected at the light reflection plane 274. The reflection angle θ continuously varies according to the position of the light reflection plane 274 on the first surface 260. The first light 321 is converted into a second light 322 having a second optical distribution, which is more uniform than the first optical distribution, and is reflected towards the liquid crystal display panel assembly 100. The varied reflection angle θ of a vertically reflected second light gradually decreases as a distance between a position at which the first light is incident and a position at which the first light is generated increases. The vertically reflected second light is a second light that is incident vertically onto a surface of a LCD panel.

The reflectivity and the transmissivity of the second light 322 reflected towards the liquid crystal display panel assembly 100 are varied depending on the reflection angle thereof.

The second light 322 has a higher reflectivity at a position that is close to the lamp assembly 300, but the transmissivity thereof is reduced. On the contrary, the second light 322 has a lower reflectivity and a higher transmissivity at a position that is remote from the lamp assembly 300.

Therefore, a portion of the second light 322 reflected by an upper surface of the light guiding plate at a position adjacent to the lamp assembly 300 is reflected again towards the upper surface of the light guiding plate 200. Then, the second light 322 reflected by the upper surface of the light guiding plate 200 is subject to a light shift process by being repeatedly reflected towards the liquid crystal display panel assembly 100 at least one time. Then, the second light 322 is outputted from the light guiding plate 200. Hereinafter, the light outputted from the light guiding plate 200 is referred to as a third light 323.

The third light 323 is incident into the liquid crystal display panel assembly 100. Then, the third light 323 is subject to an optical modulation process in the liquid crystal display panel assembly 100 so that a fourth light 324 including images are created. After that, the fourth light 324 passes through the light guiding plate 200 and is incident into eyes of a user.

As described above, in a dark place having insufficient quantity of light, the liquid crystal display device of the present invention displays information by consuming an electric energy stored therein or supplied from an outside. In a place having sufficient quantity of light, the liquid crystal display device of the present invention displays information by using the external light. When displaying information by using the electric energy, the brightness uniformity is more improved so that the high quality display is achieved.

While the present invention has been described in detail with reference to the exemplary embodiments thereof, it should be understood to those skilled in the art that various changes, substitutions and alterations can be made hereto without departing from the scope of the invention as defined by the appended claims.

What is claimed is:

1. A light guiding plate comprising:
a light incident side portion into which a light is incident;
a first surface for reflecting the light incident through the light incident side portion, the first surface having a light reflection pattern including a plurality of alternately disposed light reflection planes and non-reflection planes, the light reflection planes facing the light incident side portion so as to reflect the light inputted through the light incident side portion; and
a second surface opposite the first surface, the light reflection plane having an inclined angle with respect to the second surface, the angle being proportional to a distance between the light incident side portion and the light reflection plane.

2. The light guiding plate as claimed in claim 1, wherein the inclined angle is from about 32 degrees to about 46 degrees.

3. The light guiding plate as claimed in claim 1, wherein the light reflection pattern is inclined about 22.5 degrees or less with respect to a boundary line between the light incident side portion and the first surface.

4. The light guiding plate as claimed in claim 3, wherein the light reflection pattern is inclined about 22.5 degrees with respect to the boundary line between the light incident side portion and the first surface.

5. The light guiding plate as claimed in claim 1, wherein the second surface reflects or transmit the light reflected by the first surface depending on the inclined angle of the light reflection plane.

6. A liquid crystal display device comprising:
a lamp assembly generating a light to supply the light in one direction;
a light guiding plate including a light incident side portion into which the light is incident, a first surface for reflecting the light incident through the light incident side portion, the first surface having a light reflection pattern including a plurality of alternately disposed light reflection planes and non-reflection planes, the light reflection planes facing the light incident side portion, and a second surface opposite the first surface, the light reflection plane having an inclined angle with respect to the second surface, the angle being proportional to a distance between the light incident side section and the light reflection plane; and
a liquid crystal display panel assembly for forming an image light including display information by optically modulating the light outputted from the second surface of the light guiding plate.

7. The liquid crystal display device as claimed in claim 6, wherein the inclined angle is from about 32 degrees to about 46 degrees.

8. The liquid crystal display device as claimed in claim 6, wherein the light reflection pattern is inclined about 22.5 degrees or less with respect to a boundary line between the light incident side portion and the first surface.

9. The liquid crystal display device as claimed in claim 8, wherein the light reflection pattern is inclined about 22.5 degrees with respect to the boundary line between the light incident side portion and the first surface.

10. The liquid crystal display device as claimed in claim 6, wherein the second surface reflects or transmit the light reflected by the first surface depending on the inclined angle of the light reflection plane.

11. A method for displaying an image in a liquid crystal display device, comprising:
inputting a first light having a first optical distribution;
forming a second light having a second optical distribution by continuously reflecting the first light to have a continuously varied reflection angle;
forming a third light having a third optical distribution by transmitting a portion of the second light and reflecting again at least one time a remaining portion of the second light and transmitting the re-reflected second light, depending on the reflection angle; and
forming a fourth light including an information by optically modulating the third light through a liquid crystal.

12. The method as claimed in claim 11, wherein the varied reflection angle of a vertically reflected second light gradually decreases as a distance between a position at which the first light is incident and a position at which the first light is generated increases, the vertically reflected second light being a second light which is incident vertically onto a LCD panel.

13. The method as claimed in claim 11, wherein the first light is reflected by a first surface to form the second light, and the second light is directed toward a second surface, and the first surface has an inclined angle with respect to the second surface, the angle being from about 32 degrees to about 46 degrees.
